(19) United States
(12) Patent Application Publication
(10) Pub. No.: US 2021/0030626 A1
(43) Pub. Date: Feb. 4, 2021

(54) Electronic Pill Dispenser and Related Methods of Use

(71) Applicant: AbbVie Inc., North Chicago, IL (US)

(72) Inventor: Bhimaprasad Medhal, Lake Forest, IL (US)

(73) Assignee: AbbVie Inc., North Chicago, IL (US)

(21) Appl. No.: 16/328,305

(22) PCT Filed: Aug. 26, 2017
(86) PCT No.: PCT/US2017/049089

§ 371 Date: Feb. 26, 2019

Related U.S. Application Data
(60) Provisional application No. 62/381,967, filed on Aug. 31, 2016.

(51) Int. Cl. A61J 7/04; B65D 83/04; A61J 7/00

(52) U.S. Cl. CPC A61J 7/0481; B65D 83/0409; B65D 2585/56; A61J 7/0436; B65D 2583/0427; A61J 7/0076

(57) ABSTRACT

A pill dispenser includes a case body including a first compartment having a loading slot and a second compartment including a dispensing slot. The dispenser includes a cartridge configured to contain one or more pills and configured to align with the loading slot. The second compartment is adjacent to the first compartment. The dispenser further includes an actuator including a loading chamber. The actuator is joined to the case body proximate a first end of the case body and is rotatable about the case body from a loading position to a dispensing position. At the loading position, the loading chamber is aligned with the loading slot to receive a pill from the first compartment. At the dispensing position, the loading chamber is aligned with the dispensing slot to dispense the pill through the second compartment. A cap is removably coupled to a second end of the case body and is aligned with the second compartment and configured to receive the pill from the second compartment..

### FIELD OF THE DISCLOSED SUBJECT MATTER

The disclosed subject matter generally relates to containers for storing and dispensing medication.

### DESCRIPTION OF RELATED ART

Pill dispensers and packages can be designed to facilitate patient compliance with a desired dosing schedule. Such pill dispensers and packages can include a pill configuration, or other indicators, to allow a patient to identify and adhere to a dosing schedule. For example, push and hold dispensing package designs can be utilized by pushing a tablet from a blister pack while pulling and holding a tab of a secondary pack. In this manner, the tablet can be urged through a hole provided in the secondary packaging. In this configuration, the pills can be arranged in a calendar representation to allow the user to track the dosage schedule. Alternatively, in a squeeze and pull design, a user can dispense a dose by simultaneously squeezing tabs at each side of the package while pulling a blister pack out. In this manner, after pulling out the blister pack, the patient can push on a tablet from the blister pack to remove the pill, and then re-insert the blister pack in the package for seamless storage.

However, there remains a continued need for improved containers and techniques. For example, there remains a need for containers and techniques to allow the user to more easily adhere to a prescription regimen and clearly indicate to a user a timely reminder to take a dose. Additionally, it can also be desirable for such containers to communicate with electronic devices, such as a user's or caretaker's smart phone, which can engage a user's support network, such as family members and health professionals, for monitoring the patient's adherence to a prescription regimen.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, the disclosed subject matter includes a smart pill dispenser for storing pills, indicating to the user a time to dispense the pill, and allowing the user to dispense each pill one a time through simple rotation actions performed by the patient. The pill dispenser is also equipped with sensors and a processor and memory that can detect when a patient has dispensed a pill.

As further embodied herein, a pill dispenser includes a case body including a first compartment having a loading slot defined therein, and a second compartment including a dispensing slot defined therein. The pill dispenser further includes a cartridge configured to contain one or more pills and is configured to align with the loading slot. The second compartment is adjacent to and separated from the first compartment. The dispenser further includes an actuator including a loading chamber defined therein. The actuator is coupled to the case body proximate a first end of the case body and is rotatable about the case body from a loading position to a dispensing position. At the loading position, the loading chamber is aligned with the loading slot to receive a pill from the first compartment. At the dispensing position, where the loading chamber is aligned with the dispensing slot to dispense the pill through the second compartment. A cap is removably joined to a second end opposite to the first end of the case body and is aligned with the second compartment and configured to receive the pill from the second compartment.

As further embodied herein, the loading chamber receives the pill from the first compartment at the first end in the loading position and the pill is passed through the second compartment towards the opposing end of the case body when the actuator is rotated to the dispensing position and the dispenser is inverted.

As further embodied herein, the cartridge of pills includes a cylindrical sleeve surrounding a core. One or more channels extend along the length of the core, and each channel is configured to store the one or more pills in a stack along the length of the core. The sleeve includes a slot configured to align with at least one of the channels and the loading slot of the actuator. The core is rotatable within the sleeve to align a different channel with the slot of the sleeve.

As further embodied herein, the disclosed subject matter includes a method for using a pill dispenser, including disposing a cartridge in a first compartment of a case body, where the cartridge containing one or more pills therein. The method further includes rotating an actuator to a loading position. The actuator includes a loading chamber defined therein and is joined to the case body proximate a first end of the case body. At the loading position, the loading chamber is aligned with the loading slot to receive a pill from the first compartment. The method further includes rotating the actuator from the loading position to a dispensing position. At the dispensing position, the loading chamber is aligned with the dispensing slot to dispense the pill through the second compartment. The method further includes inverting the dispenser to pass the pill through the second compartment. A cap is removably joined to an opposing end of the case body and is aligned with the second compartment and configured to receive the pill from the second compartment.

It is understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is an exterior view of an exemplary dispenser in accordance with the disclosed subject matter, where the dispenser stores and dispenses pills for a customizable prescription regimen and instructs a user for proper dispensing of a pill, according to an illustrative embodiment of the disclosed subject matter.

FIG. 2 is an exploded view of the dispenser of FIG. 1 depicting exemplary components of the dispenser.

FIG. 3A is a top left perspective view of an exemplary case body of the dispenser of FIG. 1.

FIG. 3B is a left view of the case body of FIG. 3A

FIG. 3C is a front view of the case body of FIG. 3A..

FIG. 4A is a top view of the case body of FIG. 3A.

FIG. 4B is a bottom view of the case body of FIG. 3A.

FIG. 5 is a top left perspective view of an exemplary actuator of the dispenser of FIG. 1.

FIG. 6A is a top left perspective view of an exemplary sleeve of the dispenser of FIG. 1.

FIG. 6B is a bottom right perspective view of the sleeve of FIG. 6A.

FIG. 7A is a top back right perspective view of the case body of FIG. 3A, with portions cut away to depict portions of the interior of the case body.

FIG. 7B is an elevated top right perspective view of the case body of FIG. 3A, with portions cut away to depict portions of the interior of the case body.

FIG. 8A is a bottom right perspective view of an exemplary core of the dispenser of FIG. 1.

FIG. 8B is a diagram of the core of FIG. 8A, with portions of the core depicted as transparent to illustrate stacks of pills disposed in channels of the core.

FIG. 8C is a top left perspective view of the core of FIG. 8A.

FIG. 9A is a transparent bottom right perspective view of an exemplary cartridge included in the dispenser of FIG. 1, where the cartridge includes a sleeve and a core in a closed configuration.

FIG. 9B is an opaque bottom right perspective view of the cartridge of FIG. 9A.

FIG. 10A is a transparent bottom right perspective view of the cartridge of FIG. 1, where the cartridge is in an open configuration.

FIG. 10B is an opaque bottom right perspective view of the cartridge of FIG. 10A.

FIG. 11 is an elevated top perspective view of the case body of FIG. 3.

FIG. 12A is front perspective view of an exemplary first printed circuit assembly of the dispenser of FIG. 1.

FIG. 12B is a back perspective view of the first printed circuit assembly of FIG. 12A.

FIG. 13A is a perspective view of an exemplary second printed circuit assembly including one or more sensors.

FIG. 13B is a diagram illustrating the second printed circuit assembly of FIG. 13A disposed proximate to the actuator of FIG. 5, with the actuator in a dispensing position.

FIG. 13C is a diagram illustrating the second printed circuit assembly of FIG. 13A disposed proximate to the actuator of FIG. 5, with the actuator in a loading position.

FIGS. 14A-14C are sequential perspective views together illustrating exemplary techniques for loading the dispenser of FIG. 1.

FIGS. 15A-15F are sequential perspective views together illustrating exemplary techniques for dispensing a pill from the dispenser of FIG. 1.

FIGS. 16A-16D are perspective views with portions cut away together illustrating additional details of the cap receiving a pill when dispensing a pill from the dispenser of FIG. 1.

FIG. 17 is a diagram illustrating exemplary techniques for using the dispenser of FIG. 1.

It will be appreciated that for simplicity and clarity of illustration, elements shown in the figures have not necessarily been drawn to scale. For example, the dimensions of some of the elements can be exaggerated relative to other elements for clarity. Further, where considered appropriate, reference numerals can be repeated among the figures to indicate corresponding or analogous elements.

### DETAILED DESCRIPTION

The apparatus and methods presented herein can be used for storing and dispensing medication to a patient in an easily controlled manner and in accordance with a desired dosing schedule. As used herein, a “dispenser” or “pill dispenser” (used interchangeably herein) is intended to refer generally to a device to assist an individual (also referred to herein as a user or a patient) to store and/or carry beneficial agents, therapeutics, medication, drugs, or other consumable products which can be in the form of pills, tablets, capsules or the like. The dispenser can also dispense or provide the stored medication to the patient for the consumption in a measured dose (e.g., a number of pills over a period of time). The dispenser can also provide step-by-step instructions to a patient regarding the patient's prescription schedule and how to dispense a pill from the dispenser. The dispenser can also display different kinds of information related to the patient's pill regimen, for example, how many pills a patient has previously taken and/or is scheduled to take over a certain time period (e.g., days, weeks, months, etc.), and can inform the patient when to request a refill from a doctor or pharmacy. The dispenser can be used to dispense a wide range of desired items, including therapeutic or beneficial products. Such products can be in the form of pills, capsules, tablets or other recognized solid dose forms. As used herein, and unless otherwise noted, the term “pill” is to be interpreted broadly to include all such recognized or desired forms.

A dispenser according to the disclosed subject matter can include a processor and memory storing programmable instructions or software to provide a variety of functions. For example and without limitation, the software can be configured to notify a patient when it is the appropriate time to take a dose. The software can also provide timely instructions to the patient (e.g., by displaying steps on a screen or display) based on sensing a patient's interactions with the dispenser. The pill dispenser can also include sensors connected to the processor and memory that can detect when a patient has dispensed a pill. The pill dispenser can inform the patient whether an underdose or overdose has occurred. The processor and memory can also communicate with electronic devices, including mobile devices such as smart phones, through a Bluetooth, Near Field Communication (NFC) or other suitable communication protocol. Data related to a patient's conformance or non-conformance with a prescribed pill regimen can be transmitted to the electronic device (e.g., a smart phone) through an application, such as a “mobile app.” The mobile app can transmit data received from the dispenser to family members or health professionals, who can monitor and/or encourage the patient's conformance to the prescription regimen. The dispenser presented herein can thus facilitate and support the patient's adherence to a doctor's treatment instructions. The dispenser can also attempt to modify patient behavior towards conformance and reduce patient error, for example and without limitation, through ready display of the patient's previous history of taking the pills and/or alarms or other indicators to alert the patient when a pill should be taken.

Embodiments of the disclosed pill dispenser can securely store a set of pills to fulfill a prescription regimen over a period of weeks or months, for example, and yet be compact enough for handheld use. For purpose of illustration and not limitation, the pill dispenser can have the shape of a rectangular bottle with a cap on the top end of the dispenser and a rotatable actuator or knob on the bottom end of the dispenser. The exterior surface of the pill dispenser can include a display or screen (e.g., an electronic display) for displaying a series of steps or instructions for the patient to perform in order to dispense the pill. The interior of the pill dispenser can store a stack of 7 daily pills in a column, and a plurality of columns can be arranged in a radial array to achieve a 6-week or 1-month supply, for example and as embodied herein. A dispenser can be configured to dispense a predetermined dose (e.g., a single pill) at a particular time, based on a customizable prescription schedule (e.g., at noon every day or every twelve hours). Additionally, for illustration and not limitation, the dispenser can be easy to use for an adult, yet can include features to prevent or inhibit inadvertent use by children, for example, by having the patient perform two twists or rotations of the actuator and an inversion of the dispenser to dispense a pill from the interior of the dispenser. Further, as embodied herein, a patient can press a button on the dispenser to view a status displayed on the dispenser, where the status describes, for example and without limitation, how many doses are remaining, how many doses have been taken, and whether a dose has been missed.

As further embodied herein, a pill dispenser includes an inner case body including a first compartment for housing a cartridge of one or more pills, and a second compartment for passing the pills therethrough. The pill dispenser can include an actuator that is joined to the case body at a first end and is rotatable about the case body from a loading position to a dispensing position. The actuator can include a pill loading chamber, where in the loading position, the loading chamber of the actuator receives a pill from the first compartment through a loading slot. When the actuator is rotated to a dispensing position, the loading chamber, including the received pill, aligns with the second compartment through a dispensing slot. When the dispenser is inverted, the pill in the loading chamber passes through the dispensing slot and through the second compartment. A cap removably joined to an opposing end of the case body receives the pill passed through the second compartment. The inner case body can be surrounded by an exterior cover that includes a cutout for a display and a button for the patient to initiate interaction with the display.

In accordance with the disclosed subject matter herein, the inner case body can include a third compartment for holding a display coupled to a processor and memory. The display, processor and memory can be integrated on a first printed circuit assembly mounted onto the case body. The first printed circuit assembly includes a button coupled to the processor, memory, and display, and the button is accessible through the external surface of the cover. The third compartment can further include a second printed circuit assembly that integrates one or more sensors. A first sensor can be configured to detect the actuator's rotation, and a second sensor can be configured to detect a pill passing through the second compartment.

In accordance with a method using the pill dispenser disclosed herein, a patient can dispense a pill from the dispenser. The method can include rotating the actuator to the loading position with the pill dispenser oriented upright, which can allow a pill stored in the first compartment to move into the actuator's loading chamber. The method can further include rotating the actuator to the dispensing position, which can align the loaded pill in the loading chamber with the second compartment of the case body. The dispenser can be inverted to move the pill from the loading chamber of the actuator into the cap of the dispenser. The cap can be detached from the dispenser, and the pill can be removed from the cap by the patient. As further embodied herein, the processor, memory, display, and sensor within the dispenser can be configured to provide timely instructions describing the loading and dispensing steps.

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

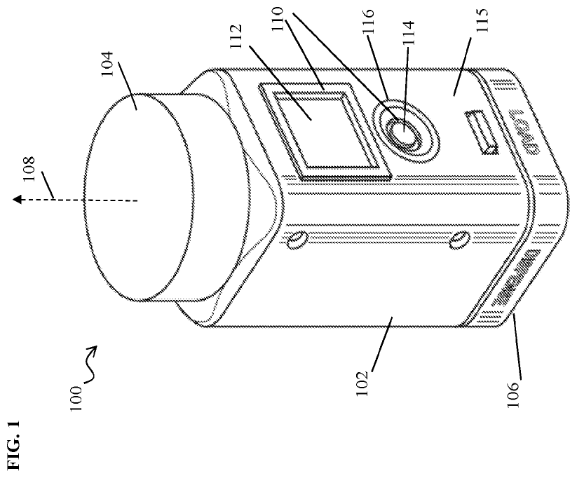

The accompanying figures, where like reference numerals refer to identical or functionally similar elements throughout the separate views, serve to further illustrate various embodiments and to explain various principles and advantages all in accordance with the disclosed subject matter. For purpose of explanation and illustration, and not limitation, exemplary embodiments of the pill dispenser are shown in FIGS. 1-17. While the present disclosed subject matter is described with respect to using the device to provide medicine in pill form to a patient, one skilled in the art will recognize that the disclosed subject matter is not limited to the illustrative embodiment, and that the dispenser can be used to store and dispense any suitable substance into a user, including any nutritional or pharmaceutical products. In addition, the components and the method of using the dispenser are not limited to the illustrative embodiments described or depicted herein.

With reference to FIG. 1, an exemplary exterior view of an assembled pill dispenser 100 is provided. For the purpose of illustration and not limitation, the dispenser 100 can have an exterior shape of a bottle, for example, as shown in FIG. 1 and as embodied herein, having a shape of a substantially rectangular prism with rounded lateral edges. The dispenser 100 can be enclosed by a cover 102 defining the overall shape of the dispenser 100. However, the dispenser can be any shape, including cylindrical, triangular, rectangular or any other suitable shape. The dispenser can further include an actuator 106 disposed proximate a first or “bottom” end of the dispenser and a cap 104 disposed proximate an opposing or “top” end of the dispenser 100. The actuator 106 can be configured to be joined to the bottom end of the dispenser 100 and rotate relative to the dispenser's cover 100 and body (see, e.g., case body 202 in FIG. 2). For example, the actuator 106 can rotate about a vertical axis 108 of the dispenser 100 and relative to the cover 102 and case body 202. The cap 104 can also be configured to be removably joined to the top end of the dispenser 100, for example, by having a threaded engagement configured to engage a corresponding threaded engagement of the body 202.

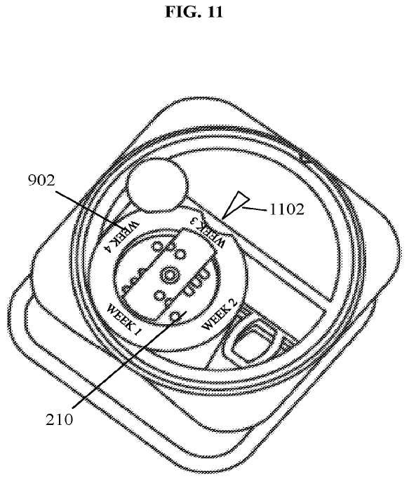

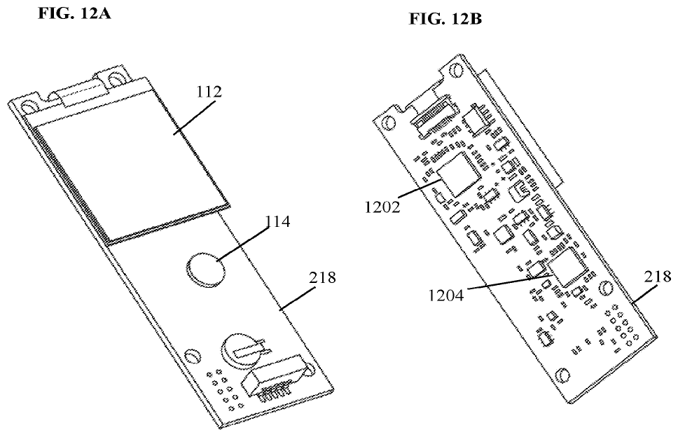

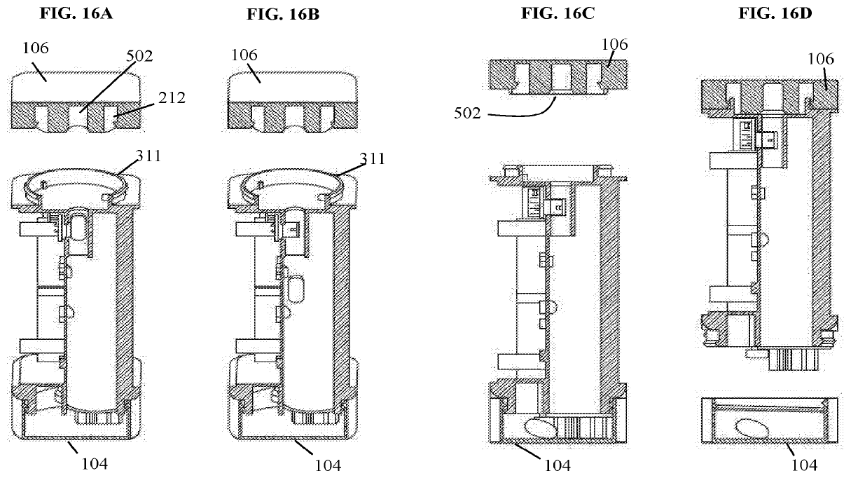

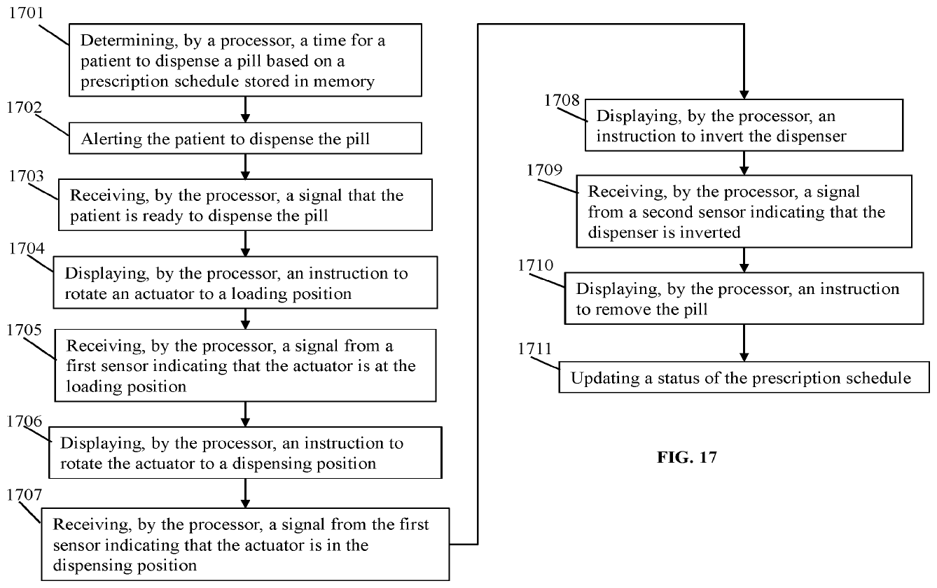

Additionally, and as embodied herein, the cover 102 of dispenser 100 can include one or more windows 110 or apertures to align with and allow access to a display 112 and a button 114 proximate the exterior front surface 115 of the dispenser 100. For the purpose of illustration and not limitation, the button 114 can be proximate to or including a light source 116, embodied herein as a light-emitting diode, and interaction with the dispenser can be performed by pressing the button 114. Other tactile interaction features can be included on the exterior of the dispenser, such as a scroll wheel or arrows, for example. In other embodiments, users can interact directly with the display 112 as a touch screen. Display 112 can be any kind of low-power display, such as an liquid crystal display or E Ink display, for example. As further explained in FIG. 17, the display 112 can provide information to the patient regarding a prescription schedule and describe steps for dispensing a pill from the dispenser 100. The display 112 can be coupled with a memory and processor configured to execute programmable instructions to display such information to the patient (see, e.g., FIGS. 12A, 12B, and 17). For the purpose of illustration and not limitation, the dispenser 100 as shown in FIG. 1 is in an upright position, with the cap 104 oriented upward and the actuator 106 oriented downward. The display can provide instructions to a user related to rotating the actuator to dispense a pill and inverting the dispenser 100 such that the cap 104 is oriented downward and the actuator 106 is oriented upward, as shown for example in FIGS.16A-16D .

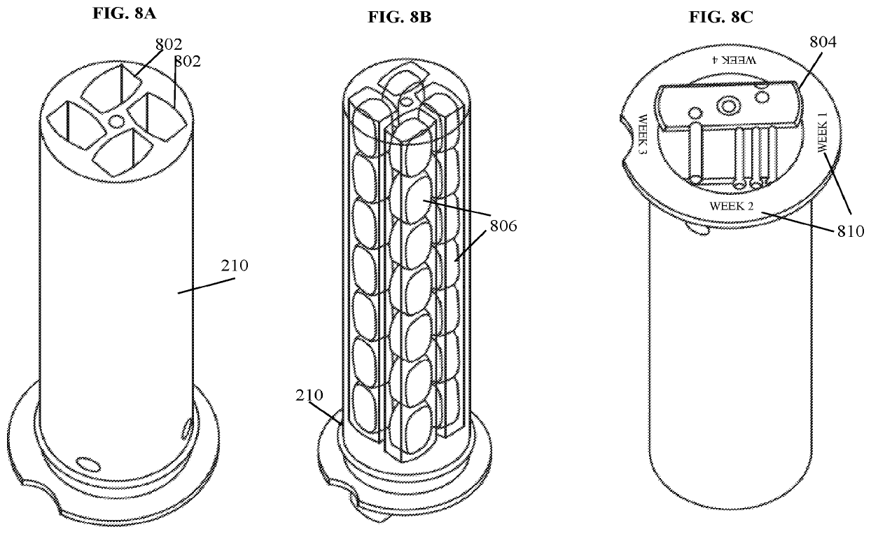

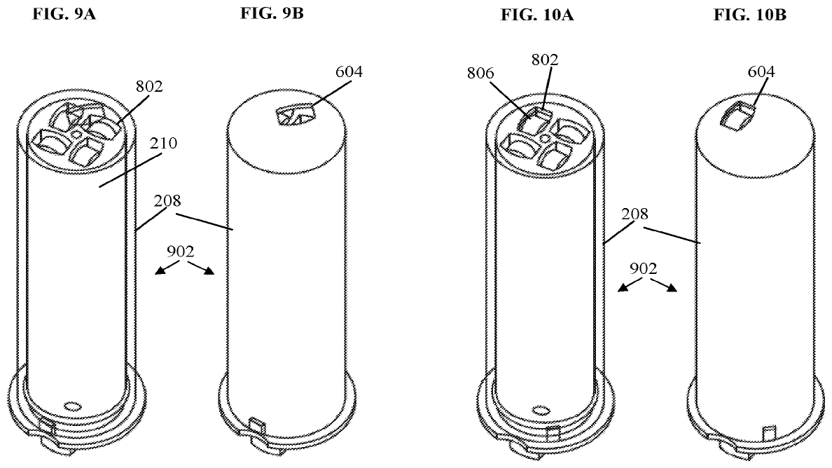

With reference to FIG. 2, an exploded view of the pill dispenser of FIG. 1 is provided. Dispenser 100 can include a case body 202 to house the various components of the dispenser in a handheld and compact form. The case body 202 can include a first compartment 204 configured to house a cartridge of one or more pills, and a second compartment 206 configured to dispense the pills from the cartridge therethrough when the dispenser is inverted. The first compartment 204 can be adjacent to the second compartment 206 by sharing a divider within the case body 202 that extends substantially along the length of the case body. The cartridge (further described in FIGS. 9A, 9B, 10A, and 10B) can include a sleeve 208 that surrounds a core 210. The core 210 can store one or more pills in channels within the core 210. For illustration and not limitation, the cartridge including the sleeve 208 and core 210 can be cylindrical, and the first compartment 204 housing the cartridge can be similarly shaped to the sleeve 208. The actuator 106 can include a groove 212 for being rotatably joined with the case body 202 at the bottom end 203 of the dispenser. The cap 104 , as shown, can be a screw cap to secure the pills within the dispenser 100. Other types of caps can be used, such as button caps or snap caps. In order to maintain a consistent bottle-like shape, the actuator 106 can have a similar shape on the side that faces the base 214 of the case body. For example, as shown, the actuator 104 can be a rectangular prism with rounded lateral edges, similar to the shape of the base 214 of the case body 202.

In some embodiments, the case body 102 can include a third compartment 216 for holding one or more processors, memory, and sensors 222 internally within the dispenser 100, and the third compartment 216 also holds a display 112 and button 114 for interacting with the dispenser 100. The display 112 and button 114 can be integrated on a first or main printed circuit assembly (PCA) 218 or printed circuit board and mounted onto the case body through one or more screw holes 220. The sensors 222 can be integrated on a second printed circuit board 224 and also mounted onto the case body 202 through screw holes 220. The third compartment 216 can also include a battery holder 226 to hold a power source for powering the electronics on the first and second printed circuit assemblies. The power source can be replaceable or rechargeable, such as replaceable or rechargeable batteries. As shown, the cover 102 can enclose the parts held by or within the case body 202. Cover 102 can also be secured to the case body 202 through screw holes. The display 112 and button 114 are both held within the third compartment 216 and shown on the exterior of the dispenser 100 through the dispenser's display window 228 and button window 230.

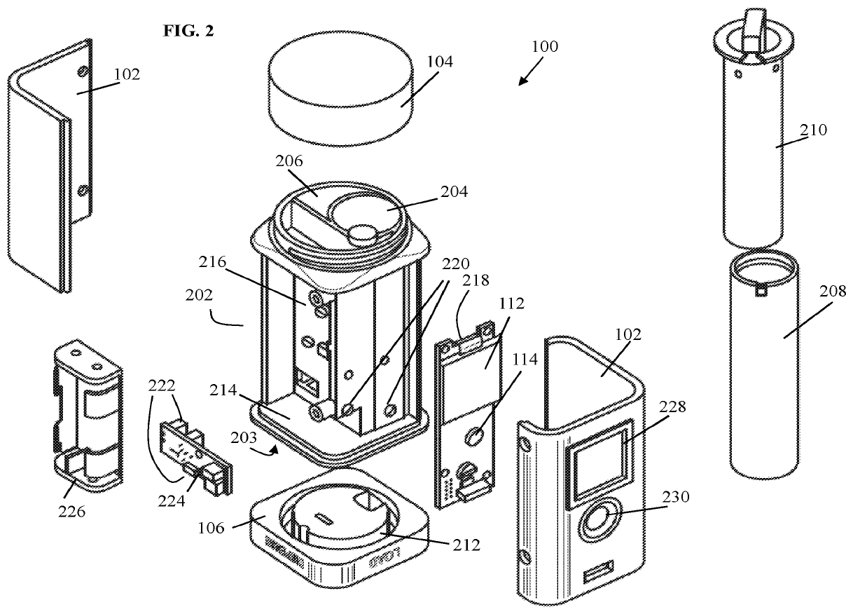

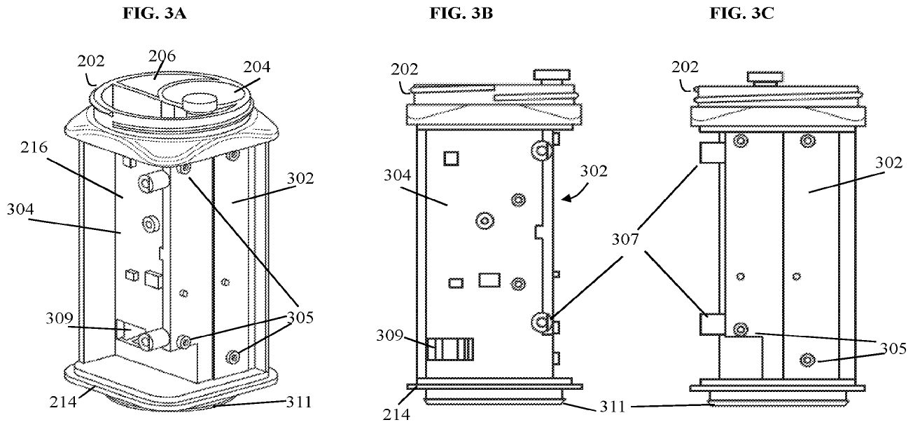

With reference to FIGS. 3A-3C, an exemplary case body 202 is illustrated. In FIG. 3A, case body 202 includes a first compartment 204 that is cylindrically enclosed and adjacent to the second compartment 206 that is substantially enclosed for a pill to pass through. As shown in FIG. 3A, and as embodied herein, the third compartment 216 is adjacent to a front side 302 of the dispenser 100 (e.g., the side where the display faces externally) and to a lateral side 304 of the dispenser 100. On the front side 302, the case body 202 can include a first set of one or more screw holes 305 for mounting the main printed circuit board, and on the lateral side, the case body 202 can include a second set of one or more screw holes 307 for mounting the second printed circuit board 224 which includes at least one sensor and the battery holder. With reference to FIG. 3A, a perspective view, and FIG. 3B, a side view of the case body 202, the third compartment 216 can further include a sensor slot 309 that leads to the second compartment 206 for passing the pill therethrough. The sensor slot 309 can allow a sensor that is integrated with the second printed circuit board 224 to detect movement of a pill in the second compartment 206 (e.g., when the pill is dispensed and removed from the dispenser). With reference to FIGS. 3B and 3C, a front view of the case body 202, the case body 202 can further include screw holes 307 for securing the cover 102. The base 214 of the case body can include a lip 311 for inserting into the groove 212 of the actuator 106 (see, e.g., FIG. 5). The case body 202 can be manufactured as one piece by recognized techniques including but not limited to injection molding and in-mold labeling, for example.

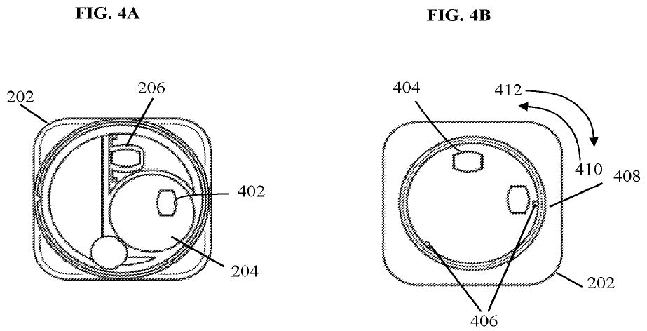

Reference is made to FIG. 4A, a top view of the case body 202, FIG. 4B, a bottom view of the case body 202, and FIG. 5, an exemplary actuator 106. The case body 202 can be substantially hollow in order to store various components of the dispenser 100. FIG. 4A illustrates the dividers between the first, second, and third compartments, where the compartments are adjacent to each other. The divider within the case body 202 can extend substantially along the length of the case body. As embodied herein, the case body 202 further includes a loading slot 402 and a dispensing slot 404, each of which is disposed on the bottom of the case body 202 and viewable from the top view of FIG. 4A, since the case body is substantially hollow. The loading slot 402 can be disposed proximate to the first compartment 204, and the dispensing slot 404 can be proximate to the second compartment 206. Reference is made to FIG. 5, where the actuator 106 includes a groove 212 that receives the lip 311 of the case body 202. The actuator 106 can be joined to the bottom end of the case body via attachment of the lip 311, and the actuator 106 can be rotatably joined to the case body. The lip 311 and groove 212 can both be circular to facilitate rotational movement. In some embodiments, the loading chamber 502 of the actuator 106 can be sized to receive only one pill from the first compartment 204. As embodied herein, the top face of the actuator 106 is proximate to the bottom face 408 of the case body shown in FIG. 4B.

According to embodiments of the disclosed subject matter describing a method of using the pill dispenser 100, as embodied herein, the actuator 106 can be rotated to a loading position in which the loading chamber 502 is aligned with the loading slot 402 of the first compartment 204. In this manner, the first compartment 204 can be in an “open” configuration, where pills stored in the first compartment 204 can fall, by gravity, into the loading chamber 502. When the loading chamber 502 has received the pill from the first compartment 204 through the loading slot 402, the actuator 106 can be rotated to a dispensing position where the loading chamber 502, which includes the received pill, is aligned with the second compartment through the dispensing slot 404. In this manner, the first compartment 204 is “closed” and no further pills can be retrieved. Further, the second compartment 206 is “open” and the pill is able to pass through the second compartment 206 by tilting or inverting the pill dispenser (e.g., turning the dispenser upside down). The pill can then be received from the second compartment 206 to the cap 104 joined to the top end of the case body. The actuator 106 can be rotated back to the loading position, either immediately or at a later time to take a subsequent dose of medication.

For the purpose of illustration and not limitation, the lip 311 on the case body shown in FIG. 4B can include one or more stoppers 406, and the groove 212 in the actuator 106 can include corresponding stoppers 504 to allow the actuator 106 to rotate to a rotational position to align the loading chamber 502 with the desired slot. As further shown in FIG. 4B, the loading slot 402 and the dispensing slot 404 can be positioned such that the actuator 106 rotates 90 degrees in one direction, e.g. counter-clockwise 410 when facing the bottom side of the case body 202, from the loading position to the dispensing position, and rotates 90 degrees in an opposite direction, e.g., clockwise 412, from the dispensing position to the loading position.

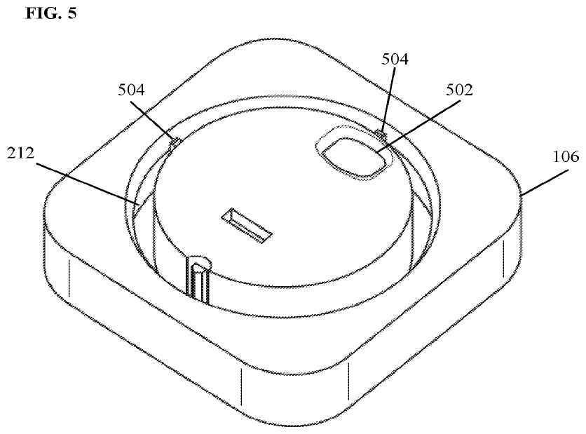

Reference is made to FIGS. 6A and 6B depicting an exemplary sleeve 208 of a cartridge that stores one or more pills. As described with respect to FIG. 2, a cartridge can include a cylindrical sleeve 208 surrounding a core 210. The sleeve 208 can include a slot 604 that is configured to align with the loading slot 402, such that the pills contained within the cartridge can pass through the loading slot 402 and be received by the loading chamber 502 in the actuator 106.

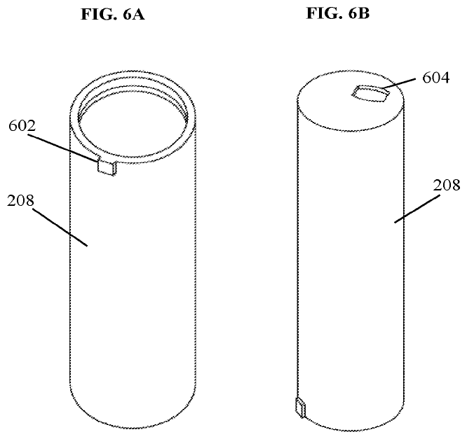

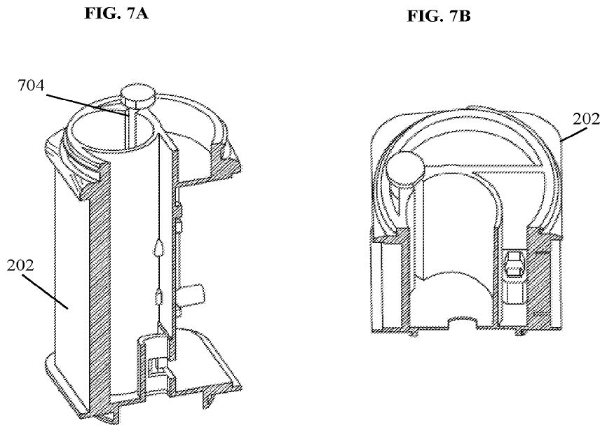

According to the disclosed subject matter, the cartridge of pills can be removable from the dispenser. In this manner, the cartridge can be easily refilled with more pills, or the cartridge can be replaced with a new cartridge containing a new prescription or refill. The cartridges can be reusable by either the patient or the pharmacy. Reference is made to FIGS. 7A and 7B, illustrating partial perspective views of the case body 202. To guide the cartridge into the right position in the first compartment 204 of the case body 202, the sleeve 208 shown in FIGS. 6A and 6B can include a key 602 or other guiding structure, like a notch or protrusion, that fits within a vertical groove 704 on the interior of the first compartment 204. When the notch 602 is disposed within the vertical groove 704 upon insertion of the cartridge, the slot 402 is aligned with the loading slot 402 at the bottom of the case body 202.

Reference is now made to FIGS. 8A-8C illustrating an exemplary core 210 storing a stack of pills 806 in accordance with embodiments of the disclosed subject matter. FIG. 8A illustrates an opaque view of the core 210 in an inverted position. As embodied herein, a core 210 can include one or more channels 802 that extend along the length of the core 210, each channel configured to store the one or more pills in a stack along the length of the core 210. FIG. 8B illustrates a transparent view of the core 210 in FIG. 8A, where the pills are stacked within each channel 802 in a single column. For the purpose of illustration and not limitation, as embodied herein, each channel can be configured to hold 7 pills corresponding to a week's dosage of a daily prescription regimen. For a daily prescription regimen, for example, each channel can hold pills for a week's dosage, and the core 210 can include 4 channels 802, corresponding to 4 weeks of pills, or about a month. The channels 802 can be configured to hold other amounts of pills, such as 4, 8, or 10 pills, for example, and the core 210 can be configured to include a different number of channels 802, such as 1 channel or 5.

According to embodiments of the disclosed subject matter, the core 210 can be configured to be rotatable within the sleeve 208, and the core 210 can include a knob 804, as shown in FIG. 8C, on the top end of the core 210 allowing a patient to rotate the core 210. The rotation of the core 210 within the sleeve 208 can “open” or “close” the cartridge for dispensing. Reference is made to FIGS. 9A and 9B, where an exemplary cartridge 902 including a sleeve 208 and core 210 in a closed configuration is inverted to illustrate the configuration of the slot 604 of the sleeve 208 relative to the channels 802 of the core 210. As described herein, a cartridge 902 of pills can be removable from the dispenser, allowing a pharmacy to easily replace or refill pills by providing a new cartridge 902 of pills. When the cartridge 902 is initially provided to the patient, the sleeve 208 and core 210 can be initially positioned out of alignment with each other and provided with a tamper evident seal (not shown), disposed on the top of the cartridge 902 and configured to prevent or inhibit rotation of the core 210 within the sleeve 208. As shown in FIG. 9A, a transparent view of the sleeve 208 and core 210, the pills can be filled within the core 210, and the channels 802 are offset or out of alignment with the slot of the sleeve 208. FIG. 9B, showing an opaque view the sleeve 208 surrounding the core 210, illustrates that the offset position of the core 210 within the sleeve 208 prevents or inhibits the passage of pills through the sleeve 208. With a tamper evident seal that sets the offset position of the core 210, a user can be assured that the pills come directly from the manufacturer or pharmacist without tampering or alteration of the contents within the core 210.

As further embodied herein, the core 210 can be rotated within the sleeve 208 so that different channels 802 can be aligned with the slot 904 of the sleeve 208. When the cartridge 902 is initially placed within the pill dispenser, and the key of the sleeve 208 is placed within the vertical groove 704 of the first compartment 204 (see, e.g., FIG. 7A), the patient can break the tamper resistant seal by rotating the core 210 to an open position. Referring to FIGS. 10A and 10B, illustrating a cartridge 902 in an “open” configuration, the core 210 can be rotated such that one of the channels 802 is aligned with the slot 904 of the sleeve 208, allowing a pill to pass through the sleeve's slot 904 and into, e.g., the loading chamber 502 of the actuator 106 (see, e.g., the loading position illustrated at FIG. 4B). As shown in FIG. 10B, illustrating an opaque view of the inverted cartridge 902, the open configuration of the cartridge 902 allows one channel of the core 210 to be open at one time. When a patient has consumed all pills of one channel, as embodied herein, the core 210 can be rotated within the sleeve 208 to align a different channel with the slot 904 of the sleeve 208.

Referring again to FIG. 8C, the top of the core 210 can include channel markings 810 that indicate a position that the core 210 should be rotated to for proper alignment of the core 210 and the slot 904 of the sleeve. For purposes of illustration and not limitation, each channel can be marked as a particular week's dosage. Referring now to FIG. 11, illustrating a top perspective view of the dispenser including the cartridge 902 of pills, the case body 202 can include an alignment marking position 1102 that indicates to the patient the rotational position of the core 210. By matching the core 210's channel markings 810 with the alignment marking position, the patient can align the proper channel of pills for loading into the loading chamber 502.

According to some embodiments of the disclosed subject matter, the pill dispenser can provide a display 112 on the dispenser's exterior to instruct the patient on an appropriate time to take a dose and describe the loading and dispensing steps for removing a pill from the dispenser. With reference to FIG. 12A and 12B, the display, processor 1202 and memory 1204 can be integrated on a first or main printed circuit assembly (PCA) mounted onto the case body 202 within the third compartment 216. As explained with respect to FIGS. 3A-3C, the main PCA 218 can be mounted by one or more screws and screw holes securing the PCA 218 to the case body 202. The processor 1202 and memory 1204 can be configured to display instructions on the display for dispensing one or more pills by displaying a description of steps rotating the actuator 106 and inverting the dispenser. As explained further in FIG. 17, the steps can be displayed in response to signals from the button 114 and the first and second sensor. A button 114 that is also integrated on the main PCA 218 and coupled to the processor 1202 and memory 1204 can be proximate to or include a light-emitting diode or other device for providing a visual signal to a patient. The memory 1204 can be configured to store a prescription schedule comprising at least one time for dispensing a pill, and the processor 1202 can be configured to turn on the light-emitting diode based on the prescription schedule. As embodied herein, the main PCA 218 can further include a third sensor that detects inversion of the dispenser 100. The sensor can be, for example, a gyrosensor configured to detect a change in orientation of the dispenser and activate the processor, memory, and/or display based on the change in orientation. For example, and as embodied herein, the dispenser can be picked up by a user, and the gyrosensor can detect a corresponding change in the orientation of the dispenser. The gyrosensor can thus produce a signal to activate the processor and memory to turn on the display and show a status of the prescription (e.g., the number of pills left or whether a dose had been taken). In some embodiments, the gyrosensor can further aid in detecting that a patient has inverted the dispenser. The processor 1202 can also be configured to communicate with a mobile device via a short range communication connection, such as a Bluetooth connection.

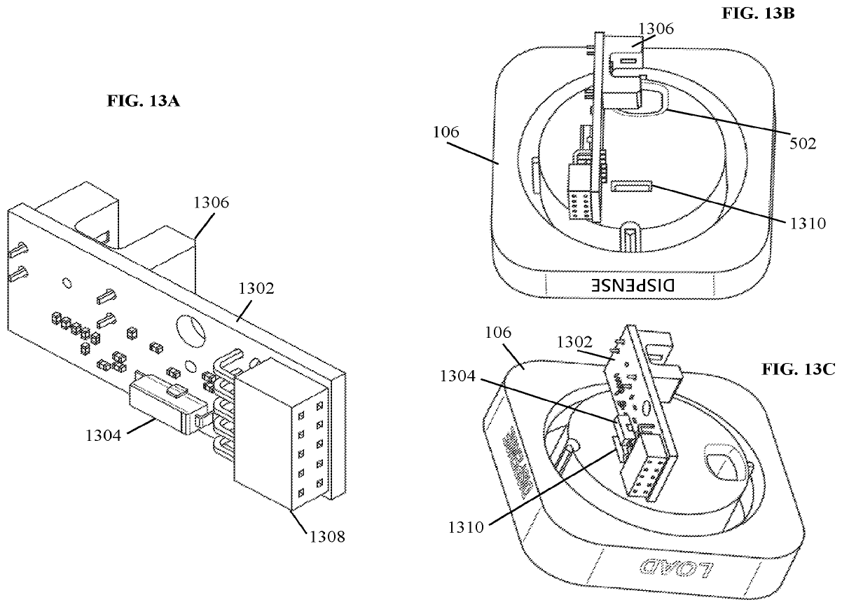

Referring to FIG. 13A, an exemplary PCA including one or more sensors 220 is provided to detect when the actuator 106 has been rotated and when the dispenser 100 has been inverted. For example, a second PCA 1302 can include a first sensor configured 1304 to detect the actuator's rotation and a second sensor 1306 configured to detect a pill passing through the second compartment 206. The first and second sensor can integrated on the second PCA 224 and coupled to the processor 1202 and memory 1204 through a connector 1308. As embodied herein, the first sensor can be a reed switch or other sensor that can detect a change in a magnetic field. The actuator 106, as shown in FIG. 13B, can include a magnet 1310 disposed proximate the top side thereof. As explained herein with reference to FIG. 3B, the second PCA 224 can be mounted to the case body 202 and disposed at least partially within the third compartment 216.

Reference is made now to FIGS. 13B and 13C illustrating the location of the second PCB 224 and sensors relative to the actuator 106 in a loading position and a dispensing position. In these figures, the case body 202 is removed from view to illustrate the position of the sensors relative to the loading chamber 502 and magnet 1310 to allow detection of particular steps performed by a patient dispensing a pill. As shown in FIG. 13B, when the actuator 106 is in a dispensing position, the photoelectric sensor, which can be located within the second compartment 206 through the sensor slot, is aligned with the loading chamber 502. (See, e.g., FIG. 3A for depiction of the sensor slot). When the patient tilts or inverts the dispenser in the dispensing step, the pill in the loading chamber 502 can fall through the second compartment 206 and proximate to the photoelectric sensor 1306. In this manner, the photoelectric sensor can detect when the patient has inverted the dispenser, and thus detect when the pill has been removed from the loading chamber 502.

As embodied herein, the reed switch can be positioned proximate to the magnetic field of the magnet 1310 embedded in the actuator 106. Although the bottom of the case body 202 is disposed between the reed switch and the magnet 1310, the reed switch can still detect the magnetic field of the actuator's magnet 1310. In FIG. 13C, when the actuator 106 is rotated to the loading position, the magnet 1310 can then be in a different orientation relative to the reed switch as compared to the dispensing position. The different orientation of the magnet 1310 allows the reed switch, by the processor 1202 and memory 1204, to detect a change in the magnetic field sensed by the reed switch. In this configuration, the reed switch can keep track of two magnetic states that indicate a dispensing position (FIG. 13B) or a loading position (FIG. 13C).

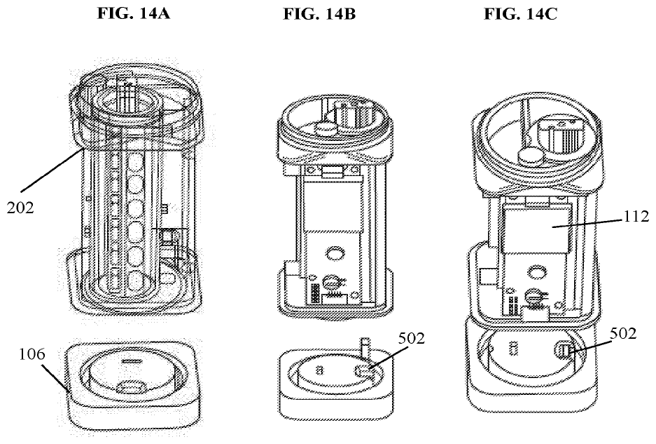

Reference is made to FIGS. 14A-14C, which are representative illustrations of exemplary loading of the dispenser 100, where the actuator 106 is partially exploded from the case body 202 of the dispenser. In FIG. 14A, while the dispenser oriented upright, as embodied herein, the actuator 106 is rotated 90 degrees to a loading position, and a partially transparent side view of the case body 202 and a cartridge 902 of pills illustrates that the loading chamber 502 is aligned with the first compartment 204 and a first channel of pills within the core 210. In FIG. 14B, illustrating a partially transparent front view of the case body 202 (facing the display 112), the alignment of the loading chamber 502 with the first compartment 204 allows a pill to drop due to gravity into the loading chamber 502. As illustrated in FIG. 14C, the pill received by the loading chamber 502 completes loading of the pill into the loading chamber 502, and the patient can be instructed to continue to the dispensing step.

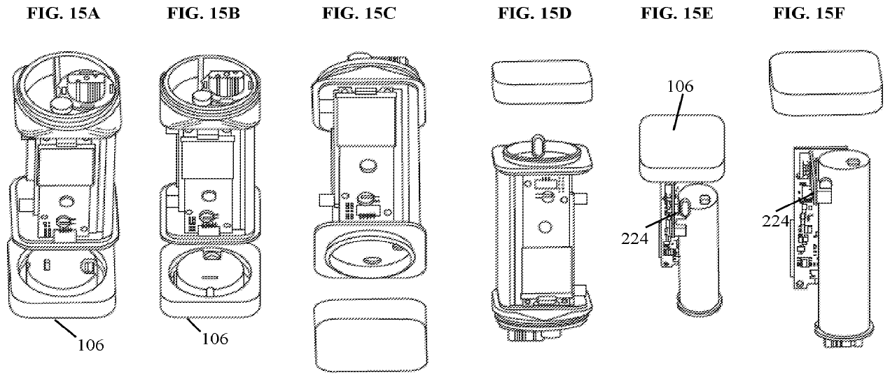

Reference is made to FIGS. 15A-15E, which are representative illustrations of exemplary dispensing of the pill, where the actuator 106 and cap 104 are partially exploded from the dispenser. In FIGS. 15A and 15B, the actuator 106 can be rotated 90 degrees counter-clockwise to a dispensing position, which aligns the loading chamber 502 containing a loaded pill with the second compartment 206 of the case body. As further illustrated in FIG. 15C, a tilted perspective view of FIG. 15C, the loading chamber 502 can also be aligned with the dispensing slot 404 of the case body, which provides a passage from the loading chamber 502 to the second compartment 206. When the dispenser 100 is inverted, as shown for example in FIG. 15D, the pill falls from the loading chamber 502 and through the second compartment 206 disposed behind the main PCA 218. In FIGS. 15E-15F, illustrating a back side of the dispenser with the case body 202 removed from view, the second PCA 224 including the photoelectric sensor is configured to detect the pill falling through the dispensing slot 404 and through second compartment 206.

Reference is made to FIGS. 16A-16D representing illustrations of a dispensing step where the cap 104 receives the pill from the second compartment 206 of the case body. In FIG. 16A, a cut-away side view of the case body, actuator 106, and cap 104 are shown when the dispenser is inverted. As embodied herein, the actuator includes a groove 212 that can be configured to engage with the lip 311 at the bottom of the case body, allowing the actuator 106 to be rotatably joined to the case body. When the dispenser is inverted, the pill enters the second compartment 206 from the loading chamber 502 while also passing the photoelectric sensor that detects the a change in lighting conditions due to the movement of the pill passed the photoelectric sensor. The pill continues through the second compartment 206 in FIG. 16B, and is received in FIG. 16C by the cap 104 that is removably joined to the case body 202 as a screw cap, for example. For illustration and not limitation, the second compartment 206 can be sized to allow only one pill through the case body 202 at one time, and thus the opening at the top of the dispenser can be narrow. When the pill is received in the cap 104, the pill can be unlikely to return back down through the second compartment 206, even if the patient returns the dispenser to an upright position. In FIG. 16D, the patient can remove the cap 104 from the case body 202 to reveal the pill for consumption.

FIG. 17 is a flow chart of an exemplary method of using a pill dispenser, according to embodiments of the disclosed subject matter. As shown in FIG. 1, pill dispenser 100 can include a display 112 and a button 114 shown on the dispenser's exterior surface. The pill dispenser can include a processor 1202 and memory 1204 coupled to the display 112 and button 114 (e.g., by being integrated in main PCB 218) and provide timely instructions and reminders for a patient to take a dose of medication in accordance with a prescribed regimen. The memory 1204 can store a prescription schedule provided by a pharmacist or doctor, for example, and a software application for a pill dispensing method executed by the processor 1202. According to embodiments of the disclosed subject matter and illustrated in FIG. 17, the processor can determine, in step 1702, a time for a patient to dispense a pill based on a prescription schedule stored in memory 1204. The prescription schedule can, for example, require a patient to take a dose or pill every 12 hours, every 18 hours, or every 24 hours. The application can record the time and day each dose is taken, and the prescription schedule can set a particular time or times each day for the patient to take a dose. In step 1702, the processor can alert the patient to dispense a pill or dose by, for example, providing a visual cue to the patient on the pill dispenser's display 112 or flashing a light provided by the button 114. For illustration and not limitation, the alert can occur within a threshold time of the time set by the prescription schedule, e.g., within 15 minutes or 5 minutes of the prescription time.

When the patient has been alerted, the patient can be instructed to press the button or other tactile input of the dispenser. In step 1703, the processor can receive a signal that the patient is ready to dispense the pill. The processor can then display, in step 1704, an instruction to rotate an actuator 106 to a loading position on the display. For example, as embodied herein, the display can display a message as follows: “Step 1: Hold upright and rotate actuator left to Load”. Other instructions can be displayed to describe the loading step. When the patient rotates the actuator, in step 1705, the processor can receive a signal from a first sensor 1304 indicating that the actuator is at the loading position. According to exemplary embodiments of the disclosed subject matter, the signal can be from a reed switch detecting a change in magnetic field from a magnet embedded in the rotated actuator.

In step 1706, the processor can then display an instruction to rotate the actuator to a dispensing position. For example, in exemplary dispensers of the disclosed subject matter, the display can display a message as follows: “Step 2: Hold upright and rotate actuator right to Dispense.” Other instructions can be displayed to describe the dispensing step. When the patient rotates the actuator to the dispensing location, in step 1707, the processor can receive a signal from the first sensor indicating that the actuator is in the dispensing position. According to exemplary embodiments of the disclosed subject matter, the signal can be from the reed switch detecting a second change in magnetic field from a magnet embedded in the rotated actuator. In step 1708, the processor can display an instruction to invert the dispenser. When the patient inverts the dispenser in step 1709, the processor can receive a signal from a second sensor indicating that the dispenser is inverted. The processor can then display an instruction, in step 1710 to remove the pill by, for example, unscrewing a cap 104 of the pill dispenser.

In step 1711, the application can update a status of the prescription schedule. The prescription schedule and application, for example, can determine whether the patient has taken the dose according to the prescription schedule by following the displayed instructions. The status update can also include determining how many pills are left in the cartridge and whether a patient needs to request a refill. The status update can also provide, for example, statistical information about the patient's adherence to the prescription schedule, including but not limited to, the percentage of times that the patient adhered to the prescription schedule, e.g. 87% or 97% adherence. This information can be stored in memory, or sent to a mobile device through a wireless connection. For example and without limitation, the information can be sent to a patient's healthcare provider or doctor for further monitoring.

For purpose of illustration and not limitation, each of the dispenser's components or parts can be made of a variety of suitable materials, including compatible plastic, polymers, composites or the like. The components can be manufactured by recognized techniques, including but not limited to injection molding, in-mold labeling, casting, milling, 3D printing or the like. A wide variety of dimensions and ergonomic shapes and features (such as surface texture, flexibility, size, weight, color, etc.) can be used as desired and suitable for the intended use.

While the disclosed subject matter is described herein in terms of certain preferred embodiments, those skilled in the art will recognize that various modifications and improvements can be made to the disclosed subject matter without departing from the scope thereof. Moreover, although individual features of one embodiment of the disclosed subject matter can be discussed herein or shown in the drawings of the one embodiment and not in other embodiments, it should be apparent that individual features of one embodiment can be combined with one or more features of another embodiment or features from a plurality of embodiments.

In addition to the specific embodiments claimed below, the disclosed subject matter is also directed to other embodiments having any other possible combination of the dependent features claimed below and those disclosed above. As such, the particular features presented in the dependent claims and disclosed above can be combined with each other in other manners within the scope of the disclosed subject matter such that the disclosed subject matter should be recognized as also specifically directed to other embodiments having any other possible combinations. Thus, the foregoing description of specific embodiments of the disclosed subject matter has been presented for purposes of illustration and description. It is not intended to be exhaustive or to limit the disclosed subject matter to those embodiments disclosed.

It will be apparent to those skilled in the art that various modifications and variations can be made in the method and system of the disclosed subject matter without departing from the spirit or scope of the disclosed subject matter. Thus, it is intended that the disclosed subject matter include modifications and variations that are within the scope of the appended claims and their equivalents.

What is claimed is:

1. A dispenser, comprising:
a case body including a first compartment having a loading slot defined therein and a second compartment including a dispensing slot defined therein, the second compartment adjacent to and separated from the first compartment;
a cartridge configured to contain one or more pills, the cartridge disposed within the first compartment and aligned with the loading slot;
an actuator including a loading chamber defined therein, the actuator coupled to the case body proximate a first end of the case body and rotatable about the case body from a loading position, wherein the loading chamber is aligned with the loading slot to receive a pill from the first compartment, to a dispensing position, wherein the loading chamber is aligned with the dispensing slot to dispense a pill through the second compartment; and
a cap removably joined to a second end opposite the first end of the case body, the cap aligned with the second compartment and configured to receive a pill from the second compartment.

2. The dispenser of claim 1, wherein the first compartment is separated from the second compartment by a divider wall extending substantially along a length of the case body.

3. The dispenser of claim 1, wherein, the loading chamber in the loading position is configured to receive a pill from the first compartment proximate the first end , and the loading chamber in the dispensing position is configured to dispense such pill through the second compartment towards the opposing end of the case body when the dispenser is inverted.

4. The dispenser of claim 1, wherein the cartridge includes a cylindrical sleeve surrounding a core having a channel extending along the length of the core, where the channel is configured to store the pill in a stack along the length of the core.

5. The dispenser of claim 4, wherein the sleeve includes a slot configured to align with the channel and the loading slot.

6. The dispenser of claim 4, wherein the core is rotatable within the sleeve to align a different channel with the slot of the sleeve.

7. The dispenser of claim 1, wherein the actuator rotates a circumferential distance in a first rotational direction from the loading position to the dispensing position, and rotates the circumferential distance in an opposite rotational direction from the dispensing position to the loading position.

8. The dispenser of claim 1, wherein the loading chamber of the actuator is sized to receive only one pill from the first compartment.

9. The dispenser of claim 1, wherein the case body includes a third compartment configured to hold a display coupled to at least one of a processor, memory and power source.

10. The dispenser of claim 9, wherein the display, processor and memory are integrated on a first printed circuit assembly mounted onto the case body.

11. The dispenser of claim 10, further comprising at least one button coupled to the first printed circuit assembly to activate the processor, memory, and display.

12. The dispenser of claim 11, comprising a cover enclosing the case body and having one or more openings configured to align with the display and the at least one button to allow access to the display and the at least one button through the cover.

13. The dispenser of claim 11, further comprising a first sensor configured to detect a rotational position of the actuator and a second sensor configured to detect a pill dispensed through the second compartment.

14. The dispenser of claim 13, wherein the first sensor and the second sensor are disposed on a second printed circuit assembly and coupled to the processor and memory.

15. The dispenser of claim 13, further comprising a third sensor configured to detect an inversion of the dispenser.

16. The dispenser of claim 13, wherein the third sensor comprises a gyrosensor configured to detect a change in orientation of the dispenser and produce a signal to activate at least one of the processor, memory, and display in response to the change in orientation.

17. The dispenser of claim 13, wherein the first sensor and the second sensor are disposed on opposite sides of the second printed circuit assembly.

18. The dispenser of claim 13, wherein the first sensor comprises a reed switch, and the actuator comprises a magnet configured to deliver a magnetic signal to the reed switch during a rotation of the actuator.

19. The dispenser of claim 13, wherein the second sensor is a photoelectric sensor configured to detect a change in lighting conditions when a pill is dispensed through the second compartment.

20. The dispenser of claim 13, wherein the processor and display are configured to provide indications to instruct a user to dispense one or more pills by rotating the actuator and inverting the dispenser, wherein at least one of the indications is displayed in response to at least one signal from the button or the first and second sensor.

21. The dispenser of claim 13, wherein the button is disposed proximate to a light source, the memory is configured to store a prescription schedule comprising at least one time for dispensing a pill, and the processor is configured to activate the light source based on the prescription schedule to provide an indication of the at least one time for dispensing a pill.

22. The dispenser of claim 9, wherein the processor is configured to communicate with a mobile device using a short range communication protocol.

23. A method for using a pill dispenser, comprising:
disposing a cartridge in a first compartment of a case body, the cartridge configured to contain one or more pills therein;
rotating an actuator to a loading position, the actuator including a loading chamber defined therein and coupled to the case body proximate a first end of the case body, wherein in the loading position, the loading chamber is aligned with a loading slot to receive a pill from the first compartment;
rotating the actuator from the loading position to a dispensing position, wherein in the dispensing position, the loading chamber is aligned with a dispensing slot to dispense a pill through a second compartment of the case body; and
inverting the dispenser to pass the pill through the second compartment, wherein a cap removably joined a second end opposite the first end of the case body is aligned with the second compartment and configured to receive a pill from the second compartment.

24. The method of claim 23, wherein rotating the actuator to the loading position comprises rotating the actuator a circumferential distance in a first rotational direction.

25. The method of claim 24, wherein rotating the actuator to the dispensing position comprises rotating the actuator the circumferential distance in an opposite rotational direction.

26. The method of claim 23, comprising receiving a signal from a processor to turn on a light source proximate to a button on the exterior of the dispenser based on a prescription schedule stored in memory, the memory coupled to the processor.

27. The method of claim 26, comprising, in response to a signal that the button is pressed according to the prescription schedule, displaying instructions on a display coupled to the processor, the instructions relating to the steps of rotating the actuator to dispense a pill.

28. The method of claim 27, wherein displaying instruction comprises displaying a first step related to a rotation of the actuator to the loading position.

29. The method of claim 28, further comprising receiving, by the processor, a signal from a first sensor, the signal indicating that the actuator has rotated to the loading position, wherein displaying instructions further comprises displaying a second step related to a rotation of the actuator to the dispensing position.

30. The method of claim 29, further comprising receiving, by the processor, a signal from the first sensor, the signal indicating that the actuator has rotated to the dispensing position, wherein displaying instructions further comprises displaying a third step related to an inversion of the dispenser.

31. The method of claim 30, further comprising receiving, by the processor, a signal from a second sensor, the signal indicating that a pill has passed through the second compartment, wherein displaying instructions further comprises displaying a message indicating that a pill has been dispensed according to the prescription schedule.

32. The method of claim 29, wherein the first sensor comprises a reed switch.

33. The method of claim 31, wherein the second sensor comprises a photoelectric sensor.

34. The method of claim 30, further comprising receiving, by the processor, a signal from a third sensor, the signal indicating that the dispenser has changed orientation, wherein the third sensor comprises a gyrosensor.

35. An apparatus for dispensing pills, comprising:
a case body including a first compartment having a loading slot defined therein;
a cartridge containing one or more pills stored therein, wherein the cartridge includes a sleeve surrounding a core, the core including one or more channels extending along a length of the core, wherein the sleeve includes a slot configured to align with the loading slot;
an actuator including a loading chamber, wherein the actuator is rotatable about the case body at a first end of the case body to a loading position, where the loading chamber receives a pill via the slot in the sleeve, wherein the actuator is further rotatable to a dispensing position, wherein the loading chamber aligns with a second compartment of the case body through a dispensing slot.
